(19) United States
(12) Patent Application Publication
(10) Pub. No.: US 2011/0000368 A1
(43) Pub. Date: Jan. 6, 2011

(54) DYNAMIC ELECTROSTATIC APPARATUS FOR PURIFYING AIR USING ELECTRONICALLY CHARGED DROPLETS

(76) Inventor: Fernando Ray TOLLENS, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/827,232

(22) Filed: Jun. 30, 2010

Related U.S. Application Data
(60) Provisional application No. 61/222,271, filed on Jul. 1, 2009.
(60) Provisional application No. 61/222,239, filed on Jul. 1, 2009.

(51) Int. Cl. B03C 3/38

(52) U.S. Cl. 95/62; 96/27

(57) ABSTRACT

A dynamic electrostatic apparatus for purifying air is provided. In some embodiments, the apparatus includes at least one emitter through which a fluid is sprayed into a plurality of electrically charged droplets that intermix with particulates in incoming air and form a plurality of charged agglomerates. A minor portion of such charged agglomerates are collected on a conductive surface and removed from the input air, while a major portion of such charged agglomerates are deflected by a deflecting element onto a collective surface. Thus, the apparatus reduces particulates in output air. In some embodiments, the emitter includes an array of hydrophilic spray fibers.

### CROSS REFERENCE TO RELATED APPLICATIONS

This application claims the benefit of U.S. Application Ser. No. 61/222,271 filed on Jul. 1, 2009 and U.S. Application Ser. No. 61/222,239 filed on Jul. 1, 2009.

### FIELD OF THE INVENTION

The present invention is directed to an air purifying apparatus which sprays electrically charged droplets into an incoming air stream to reduce particulates in the air stream.

### BACKGROUND OF THE INVENTION

Indoor air includes many small particulates which, when inhaled or otherwise contacted by human beings, have a pernicious effect. Dust alone comprises dead skin, dust mite feces, pet dander, and other microscopic (less than 10 microns in size) particulates which elicit a human immune response. There are several air purifying devices known in the art that are intended to remove such particulates from the air.

One type of air purifying device is an electrostatic air purifier. Electrostatic air purifiers utilize the charge on particulates to attract them to a specified collecting surface of an opposite electrical potential. More specifically, electrostatic air purifiers may generate micron sized liquid droplets by applying electrostatic fields to fluid feed systems. Particulates or particulates in the air may be attracted to the charged droplets forming a charged agglomerate. The charged agglomerate is then attracted to an oppositely charged collecting surface. Recent attempts to utilize electrostatic fields to purify air are disclosed in U.S. Pat. Nos. 6,471,753 (Ahn et al.) and 6,656,253 (Willey et al.).

U.S. Pat. No. 6,471,753 discloses a device for collecting dust using highly charged hyperfine liquid droplets formed through an electro-hydrodynamic atomization process. In the dust collecting device of this invention, a high voltage is applied to capillaries set within a dust guide duct and having nozzles at their tips. An electric field is thus formed between the capillaries and the duct, allowing the nozzles to spray highly charged hyperfine liquid droplets. Such liquid droplets are said to absorb dust laden in air flowing in the duct by suction force of a fan. An electrostatic dust collector is detachably coupled to the duct, while being insulated from the duct, having an electrical potential opposite to that of the highly charged liquid droplets. Thus, the dust collector electrostatically collects and removes the dust absorbed by the highly charged liquid droplets.

U.S. Pat. No. 6,656,253 discloses an apparatus for removing particles from air. The apparatus includes an inlet for receiving a flow of air and a first chamber in flow communication with the inlet, wherein a charged spray of semiconductive fluid droplets having a first electrical potential is introduced to the air flow so that the particles are electrostatically attracted to and retained by the spray droplets. The apparatus also includes an outlet in flow communication with the first chamber, wherein the air flow exits the apparatus substantially free of the particles. The first chamber of the apparatus further includes a collecting surface for attracting the spray droplets, a power supply, and a spray nozzle connected to the power supply for receiving fluid and producing the spray droplets therefrom. The apparatus may also include a second chamber in flow communication with the inlet at a first end and the first zone at a second end, wherein particles entrained in the air flow are charged with a second electrical potential opposite the first electrical potential prior to the air flow entering the first zone.

One drawback with prior electrostatic air purifiers may be the required constant cleaning of the collecting surface which limits the purifying efficiency. Another drawback may be the large droplet size produced by the emitters. Larger droplets require more fluid and where a reservoir is included in the apparatus, the apparatus has to likewise be large. The distance that the particulates must travel to become attracted to the collecting surface may also add to the large size of previous devices. Further, these apparatuses have the added drawback of producing a high level of Ozone. Accordingly, there continues to be a need for an improved apparatus and method of purifying air which efficiently removes particulates and includes consumer-friendly features.

### SUMMARY OF THE INVENTION

According to one embodiment of the present invention, there is provided an air purifying apparatus comprising: an inlet into which a flow of input air is directed, said input air containing a plurality of particulates; an outlet out of which a flow of output air is directed; at least one emitter through which a fluid is sprayed into a plurality of electrically charged droplets, said droplets comprising a first electrical potential, wherein said droplets intermix with said input air and transfer charge to a portion of said plurality of particulates forming a plurality of charged agglomerates in a first zone; a conductive surface comprising a second electrical potential, wherein a portion of said plurality of charged agglomerates are collected on said conductive surface and removed from said input air; a deflecting element comprising a third electrical potential and disposed in a second zone, said second zone in air flow communication with and downstream from said first zone; and a collective surface comprising a fourth electrical potential and disposed in said second zone, wherein said deflecting element deflects a final portion of said plurality of charged agglomerates onto said collective surface, resulting in reduced particulates in said output air.

According to another embodiment of the invention, there is provided an air purifying apparatus comprising: an inlet into which a flow of input air is directed, said input air containing a plurality of particulates; an outlet out of which a flow of output air is directed; a reservoir for containing an aqueous fluid; at least one hydrophilic spray fiber in fluid communication with said reservoir to wick said aqueous fluid therefrom and spray said aqueous fluid into a plurality of electrically charged nanodroplets, said nanodroplets comprising a first electrical potential, wherein said nanodroplets intermix with said input air and transfer charge to a portion of said plurality of particulates forming a plurality of charged agglomerates in a first zone; a conductive surface comprising a second electrical potential and disposed in said first zone, wherein a portion of said plurality of charged agglomerates are collected on said conductive surface and removed from said input air; a deflecting element comprising a third electrical potential and disposed in a second zone, said second zone in air flow communication with and downstream from said first zone, wherein said deflecting element is positioned transversally to said flow of input air flowing from said first zone; and a collective surface comprising a fourth electrical potential and disposed in said second zone, wherein said deflecting element deflects a final portion of said plurality of charged agglomerates onto said collective surface, resulting in reduced particulates in said output air.

According to yet another embodiment of the invention, there is provided a method of purifying air comprising the step of providing an air purifying apparatus comprising: an inlet into which a flow of input air is directed, said input air containing a plurality of particulates; an outlet out of which a flow of output air is directed; at least one emitter through which a fluid is sprayed into a plurality of electrically charged droplets, said droplets comprising a first electrical potential, wherein said droplets intermix with said input air and transfer charge to a portion of said plurality of particulates forming a plurality of charged agglomerates in a first zone; a conductive surface comprising a second electrical potential wherein a portion of said plurality of charged agglomerates are collected on said conductive surface and removed from said input air; a deflecting element comprising a third electrical potential and disposed in a second zone, said second zone in air flow communication with and downstream from said first zone; and a collective surface comprising a fourth electrical potential and disposed in said second zone, wherein said deflecting element deflects a final portion of said plurality of charged agglomerates onto said collective surface, resulting in reduced particulates in said output air.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings in which:

FIG. 1 is a schematic diagram illustrating air purification in one embodiment of the present invention;

FIG. 2 is a schematic diagram illustrating air purification in another embodiment of the present invention;

FIG. 3 shows an integrated refill system for the embodiment in FIG. 1;

FIG. 4 is another embodiment of an integrated refill system for an embodiment of an air purifying apparatus;

FIG. 5 is one configuration of the air purifying apparatus of the present invention;

FIG. 6 is a cross sectional view of another configuration of the air purifying apparatus of the present invention; and

FIG. 7 is a graph showing the air purifying efficacy of an air purifying apparatus in accordance with the present invention.

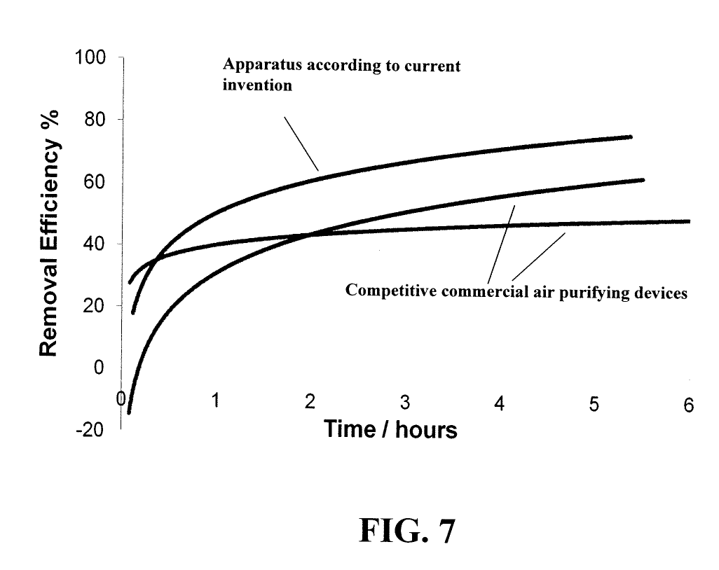

### DETAILED DESCRIPTION OF THE INVENTION

The present invention is directed to an electrostatic air purifier.

“Electrical potential” means an electrical field or voltage with respect to a counter electrode in the electrical field or voltage. Electrical potentials in complete circuits can also be classified with respect to their produced electrical currents which relate to the direction of electron flow, for example, from an area of negative electrical potential to an area of positive electrical potential.

“Purify” or “purified”, as used herein, means to treat the air with an air purifying agent and/or to remove or reduce particulates or contaminants, such as bacteria, viruses, and allergens, found in the air.

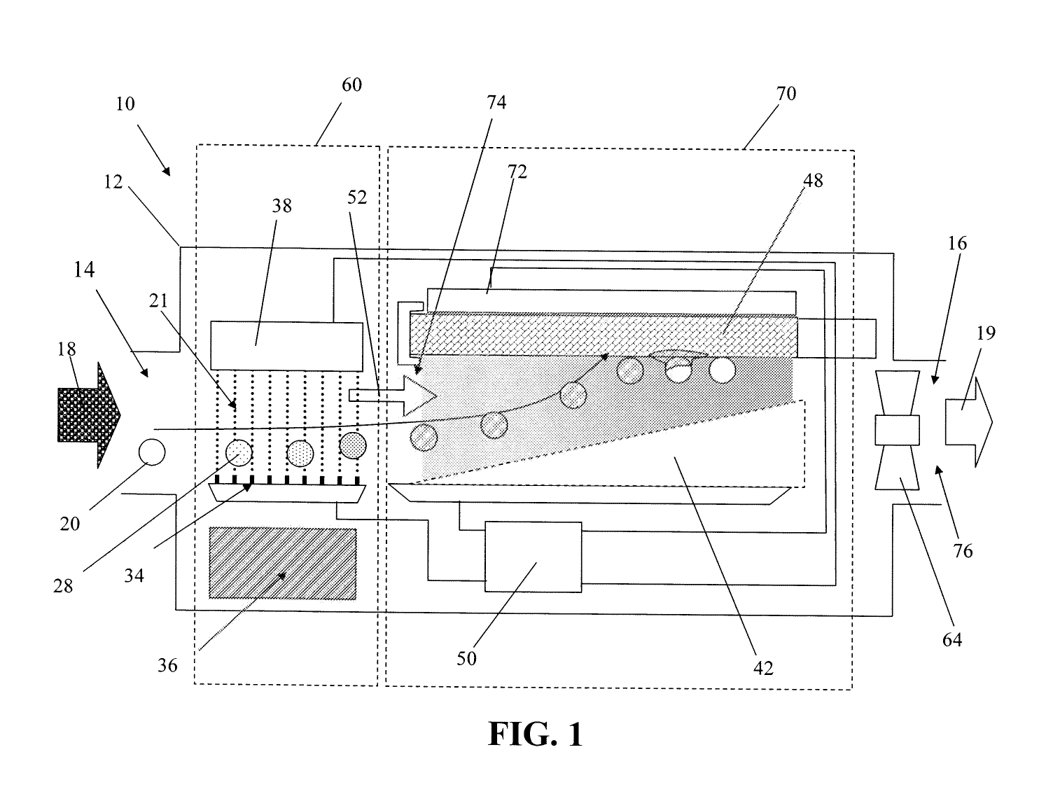

Referring to FIG. 1, an exemplary embodiment of an apparatus 10 for purifying air is shown. The apparatus 10 may include a housing 12 having an inlet 14 and an outlet 16. The apparatus 10 may also include at least one emitter 34, a conductive surface 38, a deflecting element 42, and a collective surface 48. The emitter 34, conductive surface 38, deflecting element 42, and collective surface 48 include an electrical potential such that the conductive surface 38 may provide a counter electrode for the emitter 34 and the collecting surface 48 may provide a counter electrode for the deflecting element 42. The electrical potential is provided by a power supply 50 in electrical communication with the emitter 34, conductive surface 38, deflecting element 42, and/or collective surface 48. The power supply 50 may use power from a replaceable or rechargeable batteries, power from an AC outlet, or a car DC power source.

As input air 18 having particulates 20 or other contaminants, which may range in size from about 0.1 microns to about 10 microns, enters the apparatus 10, the input air 18 intermixes with charged droplets 21 generated from an emitter 34 to form a plurality of charged agglomerates 28. A small portion of these charged agglomerates 28 may be attracted to a conductive surface 38 while a major portion of these charged agglomerates 28 are deflected by a deflecting element 42 onto a collective surface 48, thus reducing particulates in the output air 19. The operation of the apparatus 10 as an air purifier may not substantially change the air temperature or the air humidity during use.

Each of the elements that may be included in the apparatus 10 of the present invention is described in more detail below.

### Emitter

Still referring to FIG. 1, the present invention includes at least one emitter 34 for generating charged droplets 21. In some embodiments, a plurality of emitters is provided. Where an apparatus 10 includes a first zone 60 and a second zone 70, the emitter 34 is located in the first zone 60. In such an embodiment, the first zone 60 and second zone 70 may be both contributing to the efficacy of air purification. First zone 60 may substantially contribute to the removal of particulates 20 at a synergistic level of 40%, alternatively 60%, alternatively 80% of total particulates 20 removal.

The emitter 34 may be oriented in a variety of ways to draw fluid from a reservoir 36 and provide a charge on particulates 20. The emitter 34 may be supplied with fluid from the reservoir 36 by capillary, gravimetric, pumping, or like actions. The fluid may be aqueous and contain air purifying actives as discussed in more detail below. To provide a charge on the particulates 20, the emitter 34 may have a first electrical potential, provided by the power supply 50. The first electrical potential may be a positive or negative polarity. The power supply 50 may supply about 5 to about 10 kilovolts of potential which adequately serves the voltage for the air purifying apparatus 10. The first electrical potential may be lower than the air breakdown electrostatic field strength (about 3 kilovolts per cm distance), in accordance with a given geometry and air gap between the emitter 34 and the conductive surface 38, to avoid creating a corona discharge. The first electrical potential may also be high enough to impart a charge to at least a portion of the particulates 20 in the input air 18, which may have various levels of charge magnitudes and polarities.

As seen in FIG. 1, the emitter 34 may be positioned so that the electrically charged droplets 21 that are generated from the emitter 34 flow generally perpendicular to the direction of input air 18. In other embodiments, the emitter 34 is positioned so that the charged droplets 21 flow in substantially the same direction as input air 18, alternatively at an angle between substantially the same and perpendicular to the flow of input air 18.

The present invention can use virtually any type of emitter 34 known in the art of electrostatic spray devices, such as capillary tubes and fibrous wicks. In some embodiments, the emitter 34 may generate or spray micron-sized droplets. In other embodiments, the emitter 34 may generate nano-sized droplets or nanodroplets. In yet another embodiment, the emitter 34 may generate greater than 50% droplets that are nanodroplets, alternatively greater than 75%, alternatively greater than 80%, alternatively greater than 90%, alternatively 100% droplets that are nanodroplets.

Without wishing to be bound by theory, nanodroplets may provide efficient means of dispersal due to their high surface area and stability in the air or reduced tendency to settle on surfaces. In this way, the charged droplets 21 may have a greater likelihood of colliding with particulates 20 in the air to form charged agglomerates 28. Generating nanodroplets may provide the advantage of delivering a spray with a high charge density that increases the ability to charge and remove particulates. Another advantage may be that charged aqueous nanodroplets do not increase the humidity of the environment. Another potential advantage of nanodroplets is the reduced production of ozone since a lower electrical potential is required to charge a nanodroplet. Another potential advantage of nanodroplets is the low consumption of fluid. This may be preferred by consumers since it may reduce the frequency of fluid refill as well as the size of a reservoir that is needed.

In one embodiment, the emitter 34 is a hydrophilic spray fiber. Without wishing to be bound by theory, hydrophilic spray fibers may lead to a simpler, less expensive means of generating charged droplets 21, because the spray fiber is wetted by capillary action from a simple reservoir. Different from capillary tubes used in traditional electrostatic sprayers where emission is a result of the formation of Taylor cones and the subsequent Raleigh break-ups, hydrophilic spray fibers may transport fluid interstitially and/or interfacially when a multi-layer substrate is used (e.g. fibrous substrate and barrier film) to create a capillary channel. This allows only a thin layer of fluid to be exposed to the electrostatic field and to undergo emission, thus reducing the required electrical potential necessary to charge a fluid. Because only a small quantity of the fluid is exposed to the electrostatic field, the hydrophilic fibers may facilitate the creation of charged droplets 21 in the nano-size range. When hydrophilic spray fibers are used, nanodroplets may be formed independently of other processes or conditions.

A hydrophilic spray fiber or an array of hydrophilic spray fibers may be formed from a fibrous substrate or partially fibrous substrate that is punctured or pierced with an object, such as a needle. The hydrophilic spray fibers may also be formed by extruding fibers from a fibrous substrate. Alternatively, the hydrophilic spray fibers may be formed by inserting fibers through a substrate. Alternatively, an array of hydrophilic spray fibers that are separate from a substrate may be attached to the substrate by sewing, adhesives, or melting the fibers to the substrate.

Any hydrophilic substrate that will transport fluid and that provides at least one hydrophilic spray fiber when a felting needle is punched through the substrate may be used. Suitable hydrophilic substrates may comprise a woven substrate made of woven or looped cotton, velvet, silk, or the like. Suitable cottons may include fabrics having about 200 to about 650 threads per square inch. Suitable hydrophilic substrates may also comprise nonwoven substrates such as plastics, fibers, and the like. Exemplary plastic materials include, but are not limited to, thermoplastic elastomer, such as thermoplastic vulcanizate in the form of Santoprene® 8211-75 and Santoprene® 8211-55, supplied by Advanced Elastomer Systems of Akron, Ohio; thermoplastic polyurethane, such as Texin® DP7-1197, Texin® 970U, or Texin® 985U, supplied by Bayer Material Science LLC of Pittsburg, Pa.; ethylene-vinyl acetate copolymer resins, such as Elvax® 3165, supplied by DuPont of Wilmington, Del.; or any combination of the foregoing. Exemplary fiber substrates include, but are not limited to, polyethylene/polyester, polyester/co-polyester bi-component, b-component polymeric fibers, looped fibers such as those used with hook and loop fasteners, and combinations thereof. Additionally, nonwoven substrates made of hydrophilic cellulose fibers with a defined fiber length could be used to optimize the length of the spray fibers.

The hydrophilic spray fiber may be about 0 5 mm to about 8 mm in length, alternatively about 1 mm to about 5 mm, alternatively about 1.5 mm to about 3.0 mm, alternatively about 2.0 mm Any object that will relatively easily puncture a fibrous substrate by manual force may be used. In some embodiments, a sharp object such as a felting needle may be used. The felting needle may have a gauge of about 2 to about 64 gauge, alternatively about 10 to about 32 gauge, alternatively about 16 to 32, alternatively about 20 to about 24 gauge, although additional gauges may be used to achieve the desired tuft of spray fibers.

The hydrophilic spray fiber may also include any barrier film with optimal capillary feed while reducing excessive evaporation of fluid during operation of the apparatus 10. The barrier film may be made of plastic such as a low density polyethylene or polypropylene film, though other barrier films would be suitable. The barrier film may be laminated to the fibrous substrate such that, when forming the spray fiber, the barrier film is simultaneously punctured along with the fibrous substrate.

The protruding spray fibers may be separated uniformly throughout the fibrous substrate and/or barrier film. Such uniform spray fiber distribution may result in each spray fiber producing an electrostatic field strength similar to its neighbor and, in turn, provide optimum droplet formation. The distance between two or more spray fibers is at least about 3 times, alternatively at least about 2.5 times, alternatively at least about 2 times, alternatively about 2 to about 3 times, alternatively about 2 times greater than the length of the protruding spray fiber. In one embodiment, the array of hydrophilic spray fibers or tufts may be about 1 mm to about 10 mm apart, alternatively about 2 mm to about 8 mm, alternatively about 4 mm to about 6 mm, alternatively about 5 mm apart. Changing the pattern and/or tufting arrangement may provide for more of a broader or higher standard deviation profile of emitted droplets.

During emission or steady state operation, the hydrophilic spray fibers may wet and align in the direction of the electrostatic lines of force which may be substantially perpendicular to the fibrous substrate plane of the hydrophilic spray fiber. Once the charged droplets 21 are formed with an electrostatic charge on their surface, they will tend to travel very quickly between the emitter 34 and the conductive surface 38. If the distance between the emitter 34 and the conductive surface 38 is, for example, about 10 cm, then the charged droplets 21 may travel the entire 10 cm distance before the electrical charge is dissipated. The travel time may be several tenths of a second maximum and, therefore, the fluid used to create the charged droplets 21 should have a relaxation time that is in the same order of magnitude. The relaxation time of the fluid may be at least several tenths of a second, or even as much as one second.

In addition to the distance between the emitter 34 and conductive surface 38 or counter electrode, there are a variety of factors that may affect the timing, quantity, and size of the spray produced by the emitter 34. Selection of the hydrophilic fibrous material, barrier film layer, emitter density, spray fibers spacing, length of spray fibers, applied voltage, applied voltage time profile, overall emitter surface area, and punch size could all provide means for controlling the timing, quantity, and size of the spray.

### Conductive Surface

The apparatus 10 includes a conductive surface 38 that acts as a counter electrode for the emitter 34. The conductive surface 38 may be opposedly facing the emitter 34. The conductive surface 38 may be provided in the first zone 60 and spaced a predetermined distance from the emitter 34 to provide sufficient unrestricted airflow. Suitable distances may be about 10 mm to about 40 mm, alternatively about 15 mm to about 35 mm, alternatively about 20 to about 30 mm, depending on the size of the apparatus 10 and desired air flow.

The conductive surface 38 may have a second electrical potential provided by the power supply 50. The second electrical potential may be ground relative to the first electrical potential, alternatively the second electrical potential may be lower in magnitude with the same polarity as the first electrical potential, or with any magnitude and an opposite polarity than the first electrical potential. In this way, the conductive surface 38 completes an electrical circuit thus facilitating formation of charged agglomerates 28 and attraction of charged droplet 21 and a small portion of charged agglomerates 28 towards the conductive surface 38. The value of this electrical current depends on the size of the emitter 34, distance between the emitter 34 and the conductive surface 38, and the applied voltage and fluid charging properties. The total steady state current of the emitter 34 may be about 1 uA to about 30 uA, alternatively about 5 uA to about 15 uA, alternatively about 5 uA mm to about 10 uA, alternatively about 5 uA.

The conductive surface 38 may be constructed of any conductive material. Suitable conductive materials include carbon; crystalline solid or polycrystalline silicon; metals such as gold, silver, copper, alumina, nickel or iron; and electro-metalized surfaces, such as nickel or alumina plated plastics or films, graphitized plastic, film or nonwoven substrates. Other suitable surfaces include coated surfaces with conductive materials, such as conductive printable inks.

The conductive surface 38 may be configured to include apertures for facilitating conductive properties while reducing material use. Although the conductive surface 38 may include apertures, in one embodiment, it is nonporous such that it does not retain particulates 20 or charged agglomerates 28. A nonporous structure having apertures includes a mesh or metal screen. The mesh or metal screen may be a solid structure made of wires or a solid plate made from the conductive materials outlined above with punched apertures. The apertures are about equal in size to the space between the spray fibers, alternatively about half the size of the space between two or more spray fibers. The apertures of the conductive surface 38 may have a geometric pattern that corresponds to the spacing pattern between the spray fibers. Suitable screens are commonly available from many commercial suppliers with mesh sizes from about 3 mm to about 15 mm.

The conductive nature of the conductive surface 38 allows the present invention to act as a dynamic fluid electrostatic apparatus. Because some of the charged agglomerates 21 may be attracted to the conductive surface 38, it may be beneficial to make the conductive surface 38 as well as the emitter 34 low in height, permitting charged agglomerates 28 to escape into the second zone 70. A small number charged agglomerates 28 reaching the counter electrode surface 38 may discharge, releasing particulates that are likely to be reflected back into charging space due to elastic collision with the conductive surface 38. Reflected particulates may again collide with charged droplets 21, forming charged agglomerates 21, which are carried by air flow 52 into the second zone 70.

As some of the charged agglomerates 28 are collected on the conductive surface 38, its surface may be renewed. The conductive surface 38 may continue to attract charged agglomerates 28 by virtue of the electrostatic charge on its surface even after layers of charged agglomerates 21 are already established from earlier operations of the apparatus 10. It may take several months before the conductive surface 38 becomes saturated with charged agglomerates 28, rendering it ineffective. Notwithstanding the renewability of the conductive surface 38, a replaceable collection pad may be used in combination with the conductive surface 38. The features of the collection pad are discussed in more detail in the below description of the collective surface 48.

In some embodiments, the apparatus 10 may utilize any dry ionizer or dry emitter in combination with or in substitution of the emitter 34 disclosed herein. In such embodiments, the apparatus 10 will still include any combination of elements, for example the deflecting element 42 and the collective surface 48 disclosed herein.

### Deflecting Element

The apparatus 10 may include a deflecting element 42 disposed in a second zone 70. The second zone 70 may be in air flow communication with the first zone 60 at a first end 74 and with the outlet 16 at a second end 76. Charged agglomerates 28 formed from particulates 21 entrained in input air 18 are deflected by the deflecting element 42 and entrapped in the collective surface 48, thus reducing particulates 20 in the output air 19.

The deflecting element 42 may include a third electrical potential, similar to the first electrical potential of the emitter 34. In some embodiments, the first and third electrical potentials are equal. The magnitude of the third electrical potential may be high enough to deflect at least a portion of the charged agglomerates 28 towards the collective surface 48. In such an embodiment, the deflecting element 42 may be angled so as to reduce the air flow gap between the deflecting element 42 and the collective element 48 as the distance from the charging region increases. Those skilled in the art will recognize that the angle of the deflecting element 42 will influence the air flow distance required to achieve efficient collection of the charged agglomerates 28.

In some embodiments, the deflecting element 42 may provide a electrostatic field gradient in the second zone 70 as a function of distance traversed to the collective surface 48 by means of increased voltage or by means of a physical angle relative to the collective surface 48. In the case of increased voltage, the deflecting element 42 may include increasing electrical potentials as the air flow 52 moves away from the first zone 60 and closer to the outlet 16. The electrical potentials at any given point may be any voltage as long as they remain below the break down air electric field strength between the deflecting element 42 and the collective surface 48. In one embodiment, the increased electrostatic field gradient is achieved by utilizing three electrical potentials applied to three sections of the deflecting element 42 in such way that the highest potential is applied to the section closest to the outlet 16.

The deflecting element 42 may be perforated to allow unrestricted or minimally restricted air flow. The deflecting element 42 may be made from any material that conducts an electrical charge. Suitable conductive materials are those listed as suitable for use with the conductive surface 38. Similar to the conductive surface 38, the deflecting element 42 may not be porous. In this way, the deflecting element 42 does not facilitate retention of the charged agglomerates 28.

The deflecting element 42 may take the form of a mesh screen having perforations of about 1 mm to about 25 mm, alternatively in the order of about 5 mm to about 15 mm, alternatively about 5 mm The perforations may have a pitch from about 1 mm to about 25 mm, alternatively in the order of about 5 mm to about 15 mm, alternatively about 5 mm.

It will be appreciated that the deflecting element 42 may be configured in any number of ways so long as it provides unrestricted passage for air flow 52 to move unencumbered through second zone 70 and deflect charged agglomerates 28 to a collective surface 48. In the embodiment shown in FIG. 1, the deflecting element 42 is positioned transversely to the direction of air flow 52. For the purposes of an air purifying apparatus, suitable angles may be between about 5 degrees to about 80 degrees from the air flow 52, alternatively about 15 degrees to about 70 degrees, alternatively about 30 degrees to about 65 degrees. In another embodiment, the deflecting element 42 may be positioned parallel to the air flow.

In one embodiment, rather than forming a single angle relative to the collective element 48, the deflecting element 42 is curved such that it forms an increasing angle, for example, a radius or parabola relative to the collective element 48. In one embodiment, the angle of the deflecting element 42 is a parabola that matches the parabolic trajectory of the charged agglomerates 28 moving in the air flow 52 influenced by an electrical field. The desired trajectory can be calculated using commercially available fluid dynamics simulations such as Fluent Computational Fluid Dynamics from Ansys Inc. of Santa Clara Calif.

In order to better affect the charging of particulates 20, a baffle (not shown) may be provided in the second zone 70 for creating turbulence in air flowing through the apparatus 10. The baffle may not have any perforations.

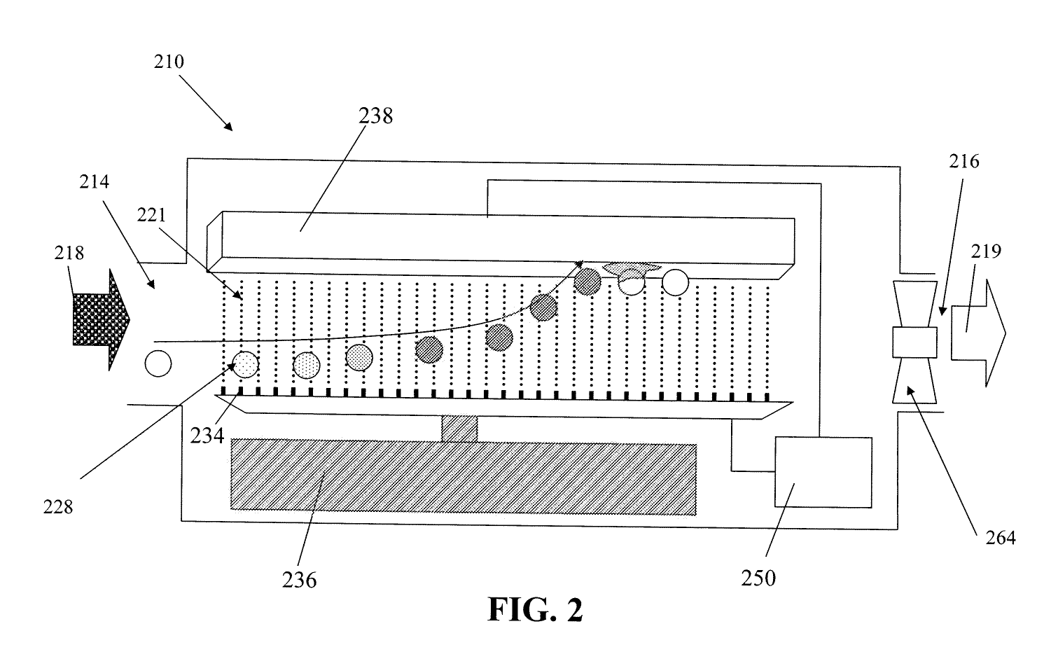

In some embodiments, the apparatus 10 may be configured without a deflecting element 42, yet still include any combination of elements disclosed herein. FIG. 2 shows one embodiment of the present invention in which the apparatus 210 is an air purifier that includes an inlet 214 into which a flow of input air 218 is directed, an outlet 216, at least one emitter 234, a conductive surface 238, and a power supply 250. In this embodiment, the emitter 234 may consist of an array of hydrophilic spray fibers as described and the apparatus 210 lacks a second zone 70, deflecting element 42, and collective surface 48. Because the apparatus 210 lacks a second zone 70 having a collective surface 48, the conductive surface 238 maybe made of soft and porous material to attract and collect charged agglomerates 21. Alternatively, the conductive surface 238 may be non-porous and include a collection pad as discussed in more detail in the below description of the collective surface 48. In the embodiment shown in FIG. 2, because the deflecting element 42 is not included, the emitters 234 may span a length greater than the length it spans in an embodiment that includes a deflecting element 242 and collective surface 248.

### Collective Surface

Still referring to FIG. 1, the apparatus 10 may include a collective surface 48 that acts as a counter electrode for deflecting element 42. The collective surface 48 may be disposed in the second zone 70 and is conductive and in electrical communication with a ground element 72. The ground element 72 defines and direct the electric field created in the second zone 70. The collective surface 48 is either grounded or charged at a fourth electrical potential that may be opposite in polarity to the first polarity of the charged agglomerates 28 to enhance attraction of the charged agglomerates 28 to the collective surface 48. In order for the apparatus 10 to perform in an effective manner, the charge on the charged agglomerates 28 may be maintained until striking collective surface 48, whereupon such charge is neutralized.

In some embodiments, the effectiveness of particulate removal may be enhanced by including an inlet 14 as described herein as well as a secondary inlet (not shown). Air flowing through the secondary inlet may be routed directly to the collective surface 48 rather than first traversing the electrostatic field between the emitter 34 and conductive surface 38.

The collective surface 48 may be made of materials that provide high collection and retention capabilities. The collective surface 48 may be a solid metal plate, solid metal bar, perforated metal plate, or the like. The combination of the ground element 72 and collective surface 48 may have a conductivity of about 20 megohm, alternatively about 10 megohm, alternatively about 5 megohm, alternatively about 1 megohm, alternatively less than about 1 megohm.

In some embodiments, the collective surface 48 is a disposable collection pad that includes conductive materials. The collection pad may be any known filter pad for filtering air as long as it is conductive. The collection pad may include carbon particles. The collection pad may have high porosity with a substantially flat surface and open cells or apertures that may represent greater than about 50% of the collective surface 48, alternatively about 50%, alternatively about 30%, alternatively about 25%, alternatively about 20%, and alternatively about 10%. The void volume within the collective surface 48 may consist of tortuous channels formed within the material such as those found in foams, sponges, and filters. Alternatively, the collective surface 48 may consist of a material with a substantially greater surface area than its dimensional area. The surface area should be in the form of tortuous voids within the volume of the collection element. The surface area to dimensional area ratio may be about greater than about 2, alternatively greater than about 4.

The porosity depends on desired ability to collect charged agglomerates 28. One skilled in the art may recognize that a surface will lose its ability to discharge charged agglomerates 28 after several layers of charged agglomerates 28 cover a conductive surface. The number or particulate layers sufficient to deactivate a surface's collection ability is about 10 to 20. As such one may modify surface area. A person skill in the art may select the use of BET theory and BET method for the measurement of the specific surface area. The BET method is widely used in surface science for the calculation of surface areas of solids by physical adsorption of gas molecules. See Lowell, S., Shields, J. E., Thomas, M. A., and Thommes, M., Characterization of Porous Solids and Powders: Surface Area, Pore Size and Density (Dordrecht, South Holland, The Netherlands Kluwer Academic Publishers, 2004, p. 67.) Materials suitable for collective surface 48 may have surface area defined by BET method as 3000 m² g₋₁, alternatively surface area of 2000 m² g⁻¹, alternatively surface area of 1000 m² g⁻¹, alternatively surface area of 500 m² g₋₁.

The collection pad of the present invention may have a total aggregate basis weight of at least about 20 g/m², alternatively at least about 40 g/m², alternatively at least about 60 g/m². The total aggregate basis weight of the present pad is typically no greater than about 275 g/m², alternatively no greater than about 200 g/m², and alternatively no greater than about 150 g/m².

The collection pad of the present invention may be formed from a single fibrous layer or at least two separate layers. The collection pad can be made using either a woven or nonwoven process, or by forming operations using melted materials laid down on forms, especially in belts, and/or by forming operations involving mechanical actions/modifications carried out on films. The structures are made by any number of methods (e.g., spunbonded, meltblown, resin bonded, heat-bonded, air-through bonded, etc.), once the desired characteristics are known. In one embodiment, the collection pad is a conductive nonwoven formed by hydro-entanglement and/or heat-bonding as is well known in the art. It is believed such materials provide open structures.

Materials suitable for forming a conductive nonwoven pad include, for example, natural celluloses as well as synthetics such as polyolefins (e.g., polyethylene and polypropylene), polyesters, polyamides, synthetic cellulosics (e.g., RAYON®), and blends thereof. Also useful are natural fibers, such as cotton or blends thereof and fibers derived from various cellulosic sources. Suitable starting materials for making the collection pad of the present invention are synthetic materials, which may be in the form of carded, spunbonded, meltblown, airlaid, or other structures. Collection pads comprising synthetic materials or fibers may have electrostatic properties. In one embodiment, the collection pad is made of carded polyester fibers. The degree of hydrophobicity or hydrophilicity of the fibers may be optimized depending upon the desired goal of the pad, either in terms of type of particulate or malodor to be removed, the type of additive that is provided, biodegradability, availability, and combinations of such considerations.

The collective surface 48 may comprise an additive. The type and level of additive is selected such that the pad has the ability to effectively remove and retain particulate material, while maintaining the electrostatic properties of the pad and minimizing the amount of reemission. As such, the additive may be non-cationic, as cationic additives may tend to diminish the electrostatic properties of the pad.

In one embodiment, the collective surface 48 is impregnated with a polymeric additive selected from a variety of acceptable polymeric additives, and mixtures thereof. Suitable polymeric additives include, but are not limited to, those selected from the group consisting of pressure sensitive adhesives, tacky polymers, and mixtures thereof. Suitable pressure sensitive adhesives comprise an adhesive polymer, which is optionally used in combination with a tackifying resin, plasticizer, and/or other optional components. Suitable tacky polymers include, but are not limited to, polyisobutylene polymers, N-decylmethacrylate polymers, and mixtures thereof.

The adhesive characteristics of a polymeric additive may provide effective particulate removal performance. Adhesive characteristics of the present polymeric additives can be measured using a texture analyzer. A suitable texture analyzer is commercially available from Stable Micro Systems, Ltd. in Godalming, Surrey UK under the trade name TA.XT2 Texture Analyser.

In another embodiment, the collective surface 48 is impregnated with anti-bacterial, anti-viral, and anti-allergen additives selected from a variety of acceptable actives, and mixtures thereof. Suitable additives include, but are not limited to, those selected from the group consisting of metal and metal oxides catalysts, ZPT, Cu, Ag, Zn, ZnO, surfactants, and EPA registered anti-bacterial and anti-viral compounds.

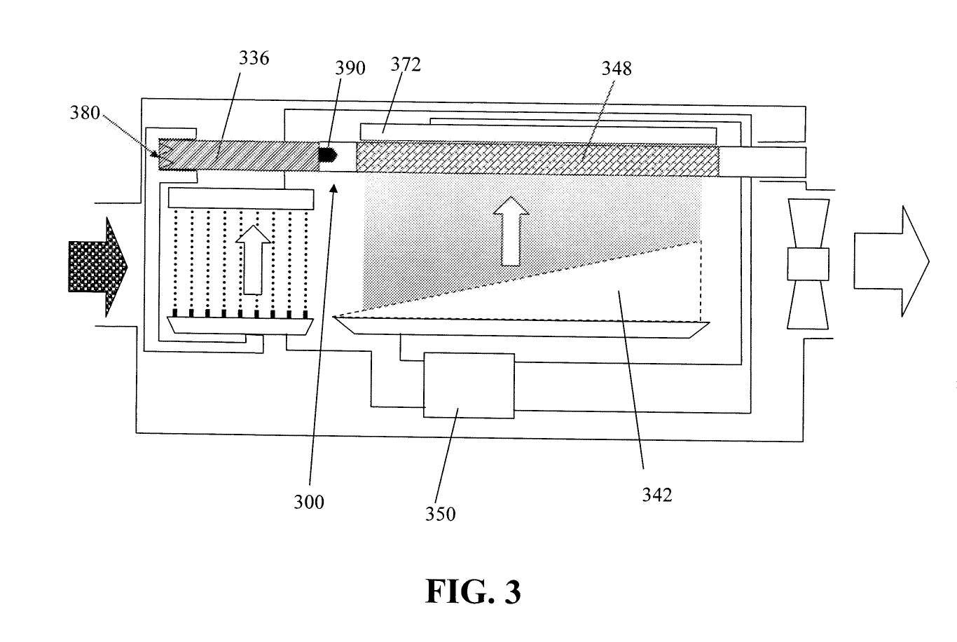

Now referring to FIG. 3, in some embodiments of the present invention, the collective surface 348 and the reservoir 336 may be manufactured as an integrated refill cartridge 300 that is replaceable. The end of life of the cartridge 300 may be 30 days, 60 days, 90 or more days. It may be especially useful for the reservoir 336 to be part of an integrated refill cartridge where an air purifying agent or solution is provided. In this way, when the air purifying agent or solution is depleted, a new cartridge 300 can be inserted into the housing 12.

More specifically, the cartridge 300 may include a housing (not shown) having an inlet in flow communication with collective surface 348 at a first end and reservoir 336 at a second end. The reservoir 336 may have a cap portion (not shown) which may consist of a rubber seal which will be punctured by at least one piercing element 380. A piercing element may be a conductive needle to provide electrical contact between the reservoir 336 and a high voltage power supply 350. The reservoir 336 may also contain an air valve 390 to equilibrate the pressure inside the reservoir 336 with outside atmospheric pressure.

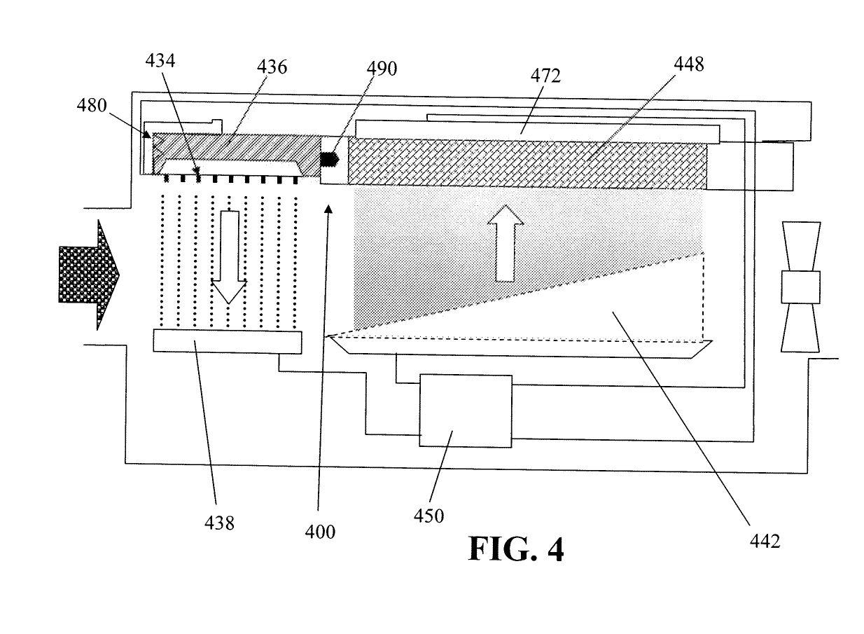

In some embodiments, as shown in FIG. 4, the cartridge 400 may include a collective surface 448, reservoir 436, and at least one emitter 434. The cartridge 400 may contain an emitter cover (not shown) which insulates emitter 434 from outside air to avoid fluid evaporation during storage and transportation. Users will remove the emitter cover before installing cartridge 400 in the apparatus 10. The particular designs of cartridge 300 can vary broadly but a person skilled in the art will recognize the need for having a connection component for connecting reservoir 336 with power supply 350 and positioning elements allowing alignment of the reservoir 336 and the emitter 334 with components of the apparatus 10 as well as allowing unrestricted fluid delivery to the emitter 334.

### Fan

Referring again to FIG. 1, outlet 16 is in air flow communication with first zone 60 so that air flow directed therethrough is substantially free of particulates 20. Moreover, in order to balance the efficiency of the apparatus 10 with the ability to substantially remove particulates 20 from air, it will be appreciated that a predetermined rate of air flow 52 through apparatus 10 is used. To better maintain a desired air flow rate, inlet 14 and/or outlet 16 may include a fan 64 to assist in pushing or drawing input air 18 from inlet 14 through to the outlet 16.

Suitable fans include axial fans, such as tube and vane; and cage fans. All these fans may be significantly more quiet than the centrifugal fans typically used in air purifiers. Since the backpressure is relatively low in the present invention, the noise of the apparatus 10 and its associated power supply is below 40 dB, alternatively it is below 35 dB, and alternatively it is below 30 dB. For small installations, this noise specification would even be less. In situations where the present invention is installed in the inlet or outlet of a furnace for a home, a separate fan/motor may not be required since the blower fan for the furnace or air conditioner would likely suffice.

### Sensors

Sensors (not shown) may be used to monitor the quality of air entering and exiting apparatus 10 and/or to monitor the quantity and flow rate of charged droplets 21 being generated from the emitter 34 to indicate the need for cartridge 300 replacement. The air quality sensor can be used to turn-on the apparatus 10, increase the fan 64 speed, or step-up the generation of charged droplets 21 from the emitter 38 to enhance air cleaning performance when it is needed. The air quality sensor can be disposed in the first zone 60 or proximate to the inlet 14. The combination of the air quality sensor at the inlet 14 and outlet 16 can provide consumers with clear signal of the apparatus' 10 performance and demonstrate its efficacy.

The sensor may include a means for measuring ozone level and may react by adjusting the potential on the emitter 34 and/or deflecting element 42 to reduce ozone level when it rises beyond an acceptable threshold. Separately, an ozone sensor can be used to halt the apparatus' 10 operations, preventing consumers from ozone contamination and/or indicating malfunction.

The sensor may also be used to directly measure fluid level in the reservoir 36 to indicate the reservoir's “end of life” in advance of fluid depletion. For example, the sensors may include an electrical circuit configured to monitor the current in the electrical circuit between the reservoir 36 and the conductive surface 38 during operation. The current in this electrical circuit may serve as an “end of life” signal by detecting the current decrease as the hydrophilic spray fibers dry out as a result of fluid depletion in the reservoir 36. The decrease in electrical current from its steady state value is used as an “end of life” signal that shuts the apparatus 10 down when fluid in the reservoir 36 is depleted or the fluid reaches a predetermined level. This drop in current draw can also be used to prevent the formation of corona discharge, which may be undesirable due to its potential of producing ozone.

The sensor may also be used to determine apparatus' 10 orientation, halting its operation if the apparatus, for example, is not in a vertical position. The sensor may also be used to assess the air flow across apparatus 10 to halt its operation if inlet or outlet of apparatus 10 is blocked or there is a malfunction of a fan 24. The sensor may further be used to control the apparatus' 10 normal operations by measuring current in the emitter 34 and collective surface 48. Under normal operation, the emitter 34 current is substantially below about 100 microamperes, alternatively substantially below about 50 microamperes. The collective surface 48 current is a function of particulates 20 concentration in the inlet air 18, but it is substantially below one microampere.

### Control Unit

A control unit (not shown) may be provided in order to operate the apparatus 10 and, more specifically, the power supply 50 and/or fan 64. The control unit may be pre-programmed or user-programmed to provide pulsing of current or voltage to the emitter. In this way, distribution of droplet size and density may be controlled over time.

The voltage time curves produced by power supply 50 may also be synchronized with the fan 64 speed and air flow speed so that optimal charging and collection potentials can be maintained as charged agglomerates 28 move through the apparatus 10. A control unit may also provide automatic regulation of the currents in the emitter 34 and collective surface 48 circuits. For example, a control unit may regulate the first potential on emitter 34 to maintain a steady current in the emitter 34 circuit at a predefined level of 100 microamperes, alternatively at 50 microamperes, alternatively at 20 microamperes, alternatively at 10 microamperes, and alternatively at 5 microamperes, depending on the size of the apparatus 10 and its configuration.

### Fluid

With regard to fluid utilized in the present invention, the fluid may be aqueous or non-aqueous and exhibit certain physical characteristics which enable it to form charged droplets 21, provide the desired spray density, and/or function effectively in attracting and retaining particulates 20 for forming charged agglomerates 28.

Such physical properties of the fluid include: viscosity, surface tension, electrical resistance, dielectric constant, flash point, boiling temperature, breakthrough voltage, and density. Suitable ranges of fluid properties are disclosed in U.S. Pat. No. 6,656,253: viscosity of the fluid (V) has a range of approximately 1-100 milliPascals; surface tension of the fluid (ST) has a range of approximately 1-100 milli-Newtons per meter; electrical resistance of the fluid (R) has a range of about 10 kilohm to about 50 megohm, alternatively about 1 to about 5 megahom; and breakthrough voltage is above 2 kilvolts per cm. The relative dielectric constant of fluids (RDC) is from about 1.0 to about 50. The flash point of fluid needs to be above 100° C. and boiling point at least above 80° C. The conductivity and dielectric properties of such fluid is controlled in order for the charged agglomerates 28 to have sufficient charge and a long relaxation time for reaching the collective surface 48. In some embodiments, the fluid may be a combination of hydrophilic and hydrophobic parts like emulsion in order to have greater affinity to particulates 20 in forming charge agglomerates 28. Additionally, the fluid may be chemically inert, of low volatility, and non-toxic for safety reasons.

A fluid capable of carrying an electrical charge for longer time periods without dissipation may be utilized. The fluid droplets dissipation or relaxation time may be greater than about 5 milliseconds, alternatively greater than about 20 milliseconds, alternatively greater than about 100 milliseconds, alternatively greater than about 1000 milliseconds. The longer relaxation time may permit better charging of incoming particulates 21 and improve their collection.

The present invention may purify air by emitting fluid containing an air purifying agent to improve the particulate removal, particulate collection on the collective surface 48, air freshening and micro activity. An air purifying agent may include anti-bacterial compounds, ionic and non-ionic surfactants, wetting agents, peroxides, ionic and non-ionic polymers, metal salts, pH buffering agents, biological agents including enzymes, natural ingredients and extracts thereof, coloring agents, and perfumes.

It is contemplated that the fluid may include vitamins, herbal ingredients, or other therapeutic or medicinal actives for the nose, throat, and/or lungs. The fluid may also contain air fresheners, perfumes, or malodor technologies, which enhance the quality of the air and have the potential to denature harmful microorganism.

### Configuration

It will be understood that various configurations and designs, in addition to those shown in FIGS. 1 to 4, may be utilized for the apparatus 10, which includes the emitter 34 and conductive surface 38.

An exemplary configuration is shown in FIG. 4 where the emitter 434 and collective surface 448 are positioned along a first axis and the conductive surface and deflecting element 442 are positioned on a second axis such that the emitter 434 opposedly faces the conductive surface 438 and the collective surface opposedly faces the deflecting element 442. The electrical potentials of each of the emitter, conductive surface, deflecting element, and collective surface are the same electrical potential described in the configuration of FIG. 1. As stated previously, in some embodiments, the apparatus 10 may be configured without a deflecting element 42, yet still include any combination of elements disclosed herein.

Where a housing 12 is present, it may be sized such that it can be used on a table top or in a room, such as a bedroom, living room, kitchen, or room having about 1200 cubic feet to 1700 cubic feet. The housing 12 may have a smaller footprint than its height to be suitable for small spaces. For example, the housing 12 may be 8 to 10 inches wide, 3 to 4 inches deep, and 10 to 12 inches tall. In some embodiments, the housing 12 is sized to be portable or configured to be used in an automobile.

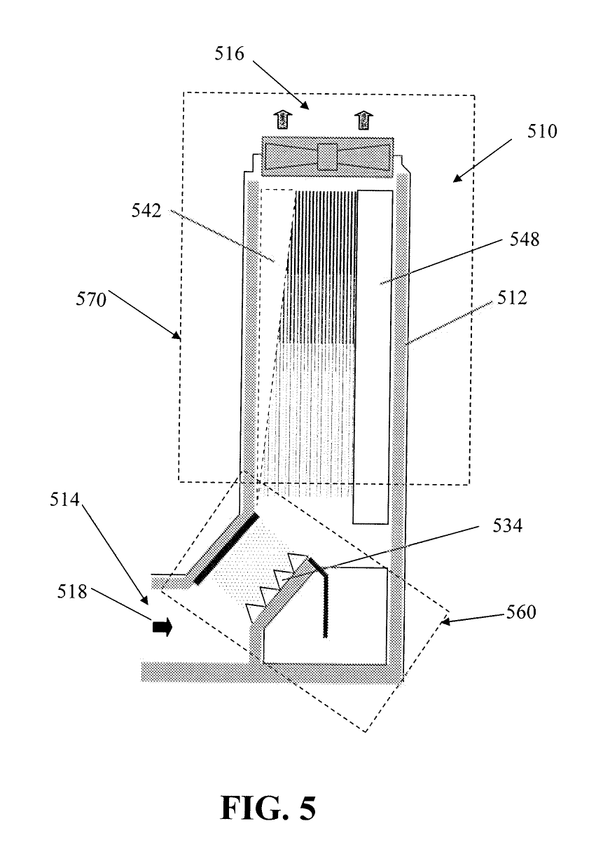

Another exemplary configuration is shown in FIG. 5 where the apparatus 510 may have a stream-lined or orthogonal parallelepiped housing 512. The housing 512 may also employ other shapes and geometries. Inlet 514 receives input air 518 containing particulates. The emitter 534 is disposed at a diagonal to flow of input air and generally opposite the deflecting element 542. Air leaving the area of the emitter 534 is then routed upward through the deflecting element 542 and collective surface 548 to the outlet 516.

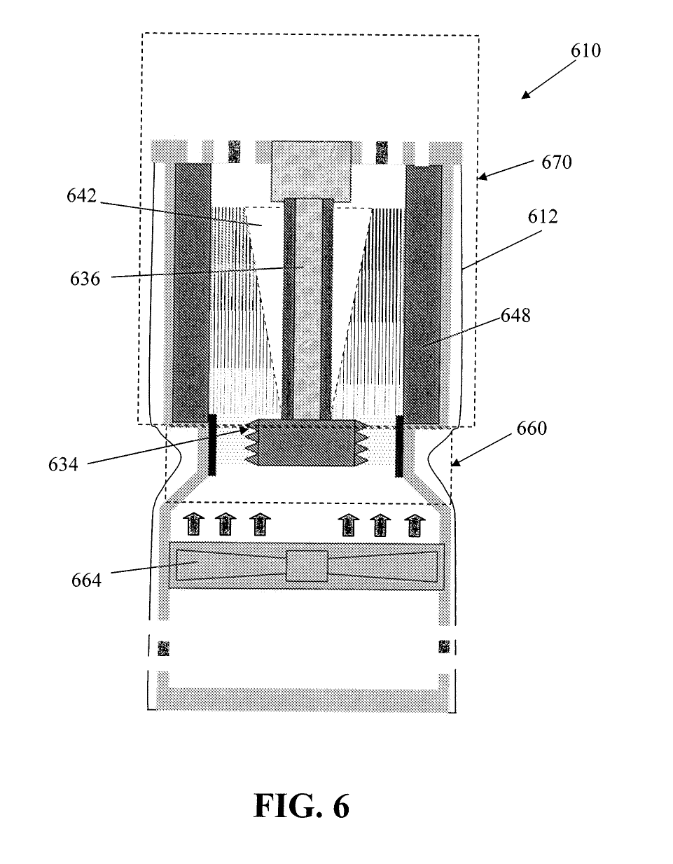

In the embodiment shown in FIG. 6, the apparatus 610 includes a cylindrical housing 612. The collective surface 638 is axi-symmetric around a centrally disposed reservoir 636. In this embodiment, an integrated refill cartridge may take the form of a ring washer, a funnel, a perforated disk, or a cylinder of wire mesh. The cartridge may include the collective surface 648 and reservoir 636.

Where the apparatus 10 of the present invention does not use a HEPA filter in the flow channel, the apparatus 10 may be configured to have a friction loss coefficient, according to Eq. 2 below, of less than about 1.4, alternatively less than about 1.3.

The friction loss coefficient (C_{w}) is a coefficient that relates density, pressure, and flow rate of a fluid in the context of a specific flow path geometry. This approach is used for, e.g., fluid flow through a tube and describes the resistance of an object to fluid flow. Eq. 1 shows the common relation:

$$Δ p = \frac{1}{2} ρ {c}_{w} {v}_{m}^{2} \qquad Eq . 1$$

where Δp is the differential pressure between a fluid inlet and fluid outlet (i.e. the pressure loss),

ρ is the density of the fluid and

νₘ, is the mean velocity of a flow.

By definition, νₘ, can be determined from the volumetric flow rate (q) divided by the cross section area of the flow channel (A). Solving Eq. 1 for C_{w}, and substituting νₘ=q/A in Eq. 1 gives:

$${c}_{w} = \frac{2}{ρ} \frac{p}{{v}_{m}^{2}} = \frac{2 {A}^{2}}{ρ} \frac{Δ p}{{\dot{q}}^{2}} \qquad Eq . 2$$

C_{w}, is a non-dimensional number. It can be determined empirically by measuring the pressure loss across an apparatus over the applied flow rate.

In one embodiment, C_{w} is 1.32 (A is 54 cm²; q is 38 cfm; Δp is about 9 Pa), fan voltage is 7 V, and the air density is 1.2 kg/m³.

In some embodiments, the apparatus 10 cleans air at an efficiency greater than 70%, with a backpressure of less than about 75 Pa, alternatively less than about 25 Pa, alternatively less than about 20 Pa, alternatively less than about 10 Pa, alternatively less than about 9 Pa, for particulates that are substantially about 0.3 microns to about 10 microns in size, at an air velocity of from about 0.1 to about 4.0 meters per second, alternatively from about 1 to about 3 meters per second, and alternatively about 2 meters per second. When using the ASHRAE dust spot test, the present invention can provide a cleaning efficiency of greater than 85% at a backpressure of less than about 25 Pa, alternatively less than about 20 Pa, alternatively less than about 10 Pa, alternatively less than about 9 Pa at the same air velocity. The cleaning performance of the apparatus 10 may stay unchanged even with increased amounts of collected particulates.

In addition to considering the friction loss coefficient, the apparatus 10 may be configured to maintain a substantially uniform electric field between the emitter 34 and the conductive surface 38. Regardless of the configuration for the emitter 34 and conductive surface 38, it will be understood that the charged droplets 21 may be distributed in a substantially homogeneous manner within the first zone 60. It has been determined that charged droplets 21 may enter first zone 60 at substantially the same velocity as input air 18 and have sufficient fly time to increase probability of their collision with particulates 20 and, in turn, reduce particulates in the atmosphere.

Another design consideration may be the charge density that is imparted to the charged droplets 21. While a higher voltage magnitude at the emitter 34 will likely ensure that charged droplets 21 successfully form at the emitter's 34 exit, any increase in charging voltage beyond the point of droplet formation has no effect on droplet size and its charge but increases its propensity for air ionization, ozone generation, and ultimately arcing. As such, it may be best to use an optimal voltage magnitude for a given distance between the emitter 34 and the conductive surface 38.

### Examples

A flat configuration (orthogonal parallelepiped) of an air purifying apparatus 510 in accordance with the present invention (see, e.g., FIG. 5) is tested for particulate removal efficiency and backpressure and noise. The first zone 560 of the air purifier has an orthogonal parallelepiped shape with a depth of about 10 cm and height of 10.16 cm, and width of about 38 cm which is positioned below the second zone 570. The second zone 570 is also orthogonal parallelepiped shape with a depth of about 10 cm, height of 25.4 cm, and width of about 38 cm. The second zone 670 also contains a flat surface deflecting element 542 of 25.4 cm in height and about 38 cm width. The deflecting element 542 is placed under an angle to the collective surface 548 so that its distance from the collective surface 548 is about 1.9 cm at the apparatus 510 outlet 516 and about 9.2 cm from the collective surface 548 at the bottom of second zone 570. The internal surface has a conductive surface and a collection pad of 25.4 cm height and about 38 cm width. The depth of conductive surface and the collection pad is about 0.7 cm. A hydrophilic spray fiber wicks array is utilized to generate electrically charged nanodroplets for charging incoming air particulates. The emitter 534 has a positive electrical potential of 10 kilovolts and can deliver substantially 50 microamperes of current through its counter electrode surface. Three fans 64 are direct current (DC) fans that operate in the range of 5 to 12 volts. The apparatus 510 is placed in a 3×3×3 meter room (27 cubic meters room) and is left running at 1.56 cubic meters per minute (CMM). Various air velocities are tested with respect to particulate removal efficiency and noise level.

A cylindrical construction of an air purifying apparatus 610 in accordance with the present invention (see e.g. FIG. 6) is tested for particulate removal efficiency and backpressure and noise.

The first zone 660 of the air purifier has a cylindrical shape with a diameter of 15.24 cm and a height of 10.16 cm. The first zone 660 is positioned below the second zone 670. Second zone 670 is also cylindrical shape with diameter of 15.24 cm and height of 25.4 cm. The second zone 670 also contains a circular truncated cone shaped deflecting element 642 of 25.4 cm in height and the outlet diameter of 13.34 cm and 0.5 cm diameter at the interconnection with first zone 660. The circular truncated cone made of metal mesh with cell size of about 8 mm and has a positive electrical potential of 10 kilovolts against collective surface 648. The internal surface has a conductive surface and a collection pad of 25.4 cm height. The emitter 634 is an array of hydrophilic spray fibers which generate electrically charged nanodroplets for charging incoming air particulates. The emitter 634 has a positive electrical potential of 10 kilovolts and can deliver substantially 100 microamperes of current through its counter electrode surface. The fan 624 is a DC fan that operates in the range of 5 to 12 volts. The apparatus 610 is placed in a 3 by 3 by 3 meter room (27 cubic meters room) and is left running at 1.56 CMM. Various air velocities are tested with respect to removal efficiency and noise levels.

Air flow rates are measured as flow velocity through the apparatus' inlet using the following equation: air flow in CMM (Q)=air flow velocity in meter per minute (V)×inlet cross sectional area in square meters (A). The flow velocity is measured using a commercial instrument by TSI Inc., VelociCheck air velocity meter, model number 8340. The results were converted into SI metric units system.

Particulate removal efficacy is measured using a commercial Climet CI-500 particle collector instrument. The particle collector uses the sample distribution; 0.3, 0.5, 1.0, 5.0, 10.0, 25.0 micron size particulates, at a sample volume of about 0.003 cubic meter and a sampling rate of one measurement per 5 minutes. The device was placed in the center of a room with dimensions of 3×3×3 meter size and a particle collector Climet CI-500 was placed˜1.2 meters away from the device. The room was equipped with an external air handling system to simulate home air turnover and a ceiling fan set at low speed to maintain room homogeneity without turbulence. The room was allowed to reach equilibrium state during at least two hours before the experiments start. An initial background particle count was obtained for a time period of 30 minutes, after which a device were turned on and left to operate for 6 hours.

Ozone levels in parts per billion (ppb) are measured using a commercial instrument AeroQual Series 500 Monitor with Ozone Sensor. The ozone sensor was placed˜1.2 meters away from the device and an initial ambient ozone level was measured for a time period of 20 minutes. After which the device was turned on and the ozone levels at the same location were measured several time for a time period of 20 minutes. The result were compared with initial ambient ozone level to determine incremental ozone contribution from the apparatus of the current invention.

Odor removal efficacy was measured in a dedicated odor evaluation room. Trained odor judges verified that there was no noticeable residual odor present in the test room. The apparatus of current invention was placed in the center of the room and 3 part per million (ppm) of allyl mercaptan was generated in the room by placing about 0.5 g of allyl mercaptan about 0.61 meters away from the apparatus. An external fan was turned on in the room to homogenize the air and to allow the odor to infuse the room. The door to the room was closed and trained odor judges performed odor evaluations (allyl mercaptan produces very strong garlic like odor) using a dedicated sniff port at the following time intervals: (1) 30 minutes prior to device switch on (2) 1 hour after activation (3) 5 hours after activation and (4) 18 hours after activation. The trained odor judges provided odor intensity measurements using a commonly used sensory rating scale from 0 to 5 grades with grade 5 been the strongest odor.

Odor Intensity Scale:

5=Pungent, i.e., extremely overpowering, permeates into nose, can almost taste it

4=strong, i.e., very room filling, but slightly overpowering

3=medium, i.e., room filling, odor character clearly recognizable

2=slight, i.e., fills part of the room, with recognizable odor character

1=Faint, i.e., diffusion is limited, odor character difficult to describe,

0=Nothing

The particulate removal results are reported in Table 1 and the noise or black flow is reported in Table 2

TABLE 1

| | |
|---|---|
| Flat (orthogonal | |
| parallelepiped) | Cylindrical |
| Configuration | Configuration |
| % Removal at given | % Removal at given |
| Time/hours | Time/hours |

| Performance | 1 | 3 | 1 | 3 |
|---|---|---|---|---|
| 0.5 | 20 | 55 | — | — |
| 1.0 | 37 | 65 | 82 | 75 |
| 5.0 | 41 | 66 | 87 | 86 |
| 10.0 | 80 | 91 | 92 | 95 |
| Back | About 25 | — | About 75 | — |
| Pressure | | | | |
| (Pa) | | | | |
| Ozone (ppb) | 16 | 18 | 20 | 18 |
| Noise (dB) | 25 | — | 22 | — |
| CMM | 1.56 | 1.56 | 1.56 | 1.56 |

TABLE 2

| Flow rate | | | | | Noise |
|---|---|---|---|---|---|
| (CMM) | 0.5 um | 1 um | 5 um | 10 um | (dB) |
| 0.68 | 81% | 88% | 88% | 90% | 20 |
| 1.1 | 64% | 73% | 72% | 83% | 23 |
| 1.8 | 47% | 57% | 56% | 68% | 30 |
| 2.5 | 32% | 41% | 44% | 61% | 42 |

Additional tests under the same conditions resulted in particulate removal data obtained using the orthogonal parallelepiped shaped apparatus performing at 1.56 CMM air flow rate.

TABLE 3

| | % Removal at | | | | | |
|---|---|---|---|---|---|---|
| Particle | given Time (hours) | | | | | |
| Size/μm | 0.5 | 1 | 2 | 3 | 4 | 5 |
| 0.3 | 2 | 2 | 3 | 26 | 28 | 33 |
| 0.5 | 7 | 20 | 29 | 55 | 57 | 58 |
| 1.0 | 16 | 37 | 41 | 65 | 66 | 66 |
| 5.0 | 23 | 41 | 44 | 66 | 66 | 67 |
| 10.0 | 74 | 80 | 82 | 91 | 91 | 91 |
| 25.0 | 100 | 100 | 100 | 100 | 100 | 100 |

Malodor removal efficacy data obtained under the same conditions using the orthogonal parallelepiped shaped apparatus performing at 1.56 CMM

TABLE 4

| | |
|---|---|
| | Odor Grade at |
| Fluid | Time (hours) |

| Composition | 0 | 1 | 5 | 18 |
|---|---|---|---|---|
| DI H₂O | 5 | 5 | 4 | 2 |
| 1% H₂O₂ | 4 | 3 | 3 | 2 |

The results demonstrate that fluid compositions may play a substantial role in rate of odor removal and the use of oxidative species such as H₂O₂ may speed up removal of organic air contaminants.

Every numerical range given throughout this specification will include every narrower numerical range that falls within such broader numerical range, as if such narrower numerical range were all expressly written herein. Further, the dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An air purifying apparatus comprising:
a. an inlet into which a flow of input air is directed, said input air containing a plurality of particulates;
b. an outlet out of which a flow of output air is directed;
c. at least one emitter through which a fluid is sprayed into a plurality of electrically charged droplets, said droplets comprising a first electrical potential, wherein said droplets intermix with said input air and transfer charge to a portion of said plurality of particulates forming a plurality of charged agglomerates in a first zone;
d. a conductive surface comprising a second electrical potential, wherein a portion of said plurality of charged agglomerates are collected on said conductive surface and removed from said input air;
e. a deflecting element comprising a third electrical potential and disposed in a second zone, said second zone in air flow communication with and downstream from said first zone; and
f. a collective surface comprising a fourth electrical potential and disposed in said second zone, wherein said deflecting element deflects a final portion of said plurality of charged agglomerates onto said collective surface, resulting in reduced particulates in said output air.

2. The air purifying apparatus of claim 1, wherein said first electrical potential is greater than said second electrical potential and said third electrical potential.

3. The air purifying apparatus of claim 1, wherein said first electrical potential is equal to said third electrical potential.

4. The air purifying apparatus of claim 1, wherein said second electrical potential is equal to said fourth electrical potential.

5. The air purifying apparatus of claim 1, wherein said deflecting element is positioned transversally to said flow of input air and configured to provide unrestricted passage of air flow in said second zone and through to said outlet.

6. The air purifying apparatus of claim 1, wherein said deflecting element is positioned at an angle of about 15 degrees to about 75 degrees to said flow of input air.

7. The air purifying apparatus of claim 1, wherein said deflecting element is positioned at an angle of about 30 degrees to about 60 degrees to said flow of input air.

8. The air purifying apparatus of claim 1, wherein said deflecting element is positioned at an angle of about 45 degrees to said flow of input air.

9. The air purifying apparatus of claim 1, wherein said collective surface comprises a replaceable collection pad.

10. The air purifying apparatus of claim 1, wherein said at least one emitter is a hydrophilic spray fiber.

11. The air purifying apparatus of claim 1, wherein said fluid is fed to said at least one emitter by a fluid feed system.

12. The air purifying apparatus of claim 1, wherein said fluid is fed to said at least one emitter by capillary action.

13. The air purifying apparatus of claim 1, further comprising a reservoir in fluid communication with said at least one emitter.

14. The air purifying apparatus of claim 1, wherein said fluid is aqueous.

15. The air purifying apparatus of claim 1, wherein said fluid comprises an air purifying agent.

16. The air purifying apparatus of claim 15, wherein said air purifying agent is selected from the group consisting of: peroxides, non-ionic surfactants, wetting agents, and combinations thereof.

17. The air purifying apparatus of claim 1, wherein said fluid is semiconductive.

18. The air purifying apparatus of claim 17, wherein said semiconductive fluid is a non-aqueous liquid.

19. The air purifying apparatus of claim 17, wherein said fluid exhibits a conductivity of less than about 10⁻⁴ ohm⁻¹ m⁻¹.

20. The air purifying apparatus of claim 1, further comprising an air quality sensor.

21. The air purifying apparatus of claim 1, further comprising an end-of-life sensor.

22. The air purifying apparatus of claim 1, wherein said apparatus is configured to have a friction loss coefficient of less than about 1.4

23. The air purifying apparatus of claim 1, wherein said apparatus comprises a backpressure of less than about 25 Pa, and overall purifying process is performed without substantial change to the temperature and humidity of said output air.

24. The air purifying apparatus of claim 1, wherein said flow of input air passes in said inlet at an air velocity of substantially 2.54 meters per second (500 fpm), and wherein said portion of said plurality of charged particulates, according to a ASHRAE dust spot test, is removed from said flow of input air at a purifying efficiency of greater than about 85% and at a backpressure of less than about 25 Pa, without substantial change to temperature and humidity of said output air.

25. The air purifying apparatus of claim 1, further comprising a ground element in electrical communication with said collective surface to create attraction for and improve retention of said plurality of charged agglomerates.

26. The air purifying apparatus of claim 1, further comprising an integrated refill cartridge comprising a reservoir and a collection pad.

27. The air purifying apparatus of claim 1, further comprising a baffle disposed in said second zone to create turbulence in air flow and increase particulate removal from said output air.

28. The air purifying apparatus of claim 1, wherein said at least one emitter is a hydrophilic spray fiber.

29. An air purifying apparatus comprising:
a. an inlet into which a flow of input air is directed, said input air containing a plurality of particulates;
b. an outlet out of which a flow of output air is directed;
c. a reservoir for containing an aqueous fluid;
d. at least one hydrophilic spray fiber in fluid communication with said reservoir to wick said aqueous fluid therefrom and spray said aqueous fluid into a plurality of electrically charged nanodroplets, said nanodroplets comprising a first electrical potential, wherein said nanodroplets intermix with said input air and transfer charge to a portion of said plurality of particulates forming a plurality of charged agglomerates in a first zone;
d. a conductive surface comprising a second electrical potential and disposed in said first zone, wherein a portion of said plurality of charged agglomerates are collected on said conductive surface and removed from said input air;
e. a deflecting element comprising a third electrical potential and disposed in a second zone, said second zone in air flow communication with and downstream from said first zone, wherein said deflecting element is positioned transversally to said flow of input air flowing from said first zone; and
f. a collective surface comprising a fourth electrical potential and disposed in said second zone, wherein said deflecting element deflects a final portion of said plurality of charged agglomerates onto said collective surface, resulting in reduced particulates in said output air.

30. The air purifying apparatus of claim 29, wherein said aqueous fluid comprises an air purifying agent.

31. The air purifying apparatus of claim 29, wherein said aqueous fluid comprises an air purifying agent selected from the group consisting of: peroxides, non-ionic surfactants, wetting agents, and a combination thereof.

32. The air purifying apparatus of claim 29, wherein said deflecting element is positioned at an angle of about 15 degrees to about 75 degrees to said flow of input air.

33. The air purifying apparatus of claim 29, wherein said deflecting element is positioned at an angle of about 30 degrees to about 60 degrees to said flow of input air.

34. The air purifying apparatus of claim 29, wherein said deflecting element is positioned at an angle of about 45 degrees to said flow of input air.

35. The air purifying apparatus of claim 29, wherein said collective surface comprises a replaceable collection pad.

36. The air purifying apparatus of claim 29, wherein said flow of input air passes in said inlet at an air velocity of substantially 2.54 meters per second (500 fpm), and wherein said portion of said plurality of charged particulates, according to a ASHRAE dust spot test, is removed from said flow of input air at a purifying efficiency of greater than about 85% and at a backpressure of less than about 25 Pa, without substantial change to temperature and humidity of said output air.

37. The air purifying apparatus of claim 29, wherein said apparatus is configured to have a friction loss coefficient of less than about 1.4.

38. The air purifying apparatus of claim 29, wherein said apparatus comprises a backpressure of less than about 25 Pa, and overall purifying process is performed without substantial change to the temperature and humidity of said input air.

39. A method of purifying air comprising the step of providing an air purifying apparatus of claim 1.
